(19) United States
(12) Patent Application Publication
(10) Pub. No.: US 2007/0084512 A1
(43) Pub. Date: Apr. 19, 2007

(54) Marine vessel water intake control system, device, and method

(76) Inventors: Edward Harris Tegge JR., Palm Bay, FL (US); Ronald Dean Tegge, Palm Beach Gardens, FL (US)

Correspondence Address: Patents On Demand, P.A., 4581 Weston Road #345, Weston, FL, 33331, US

(21) Appl. No.: 11/250,658

(22) Filed: Oct. 14, 2005

(51) Int. Cl. G05D 7/06

(52) U.S. Cl. 137/487.5

(57) ABSTRACT

A system for providing water to a marine vessel can include a water source for providing water to marine vessels, a water system of a marine vessel, and a flow control mechanism. The flow control mechanism can include a flow control valve, at least one sensor, and flow control electronics. The sensor can sense a condition relating to water flowing between the water source and the water system. The flow control electronics can automatically determine based upon data provided by the sensor whether a breach exists within the vessel's water system. The flow control electronics can automatically close the flow control valve upon detecting a breach. The flow control electronics can automatically detect a correction of the breach and can resume the flow of water responsive to the correction. The flow control electronics can also detect a user's input to manually override an automated shutdown.

### BACKGROUND

1. Field of the Invention

The present invention relates to the field of marine vessels, and, more particularly, to a water intake control systems for marine vessels.

2. Description of the Related Art

Marine vessels, such as yachts, cruise liners, barges, houseboats, fishing boats, and the like, are typically equipped with a fresh water system. When the marine vessel docks, these fresh water systems can be filled using a dockside pressurized fresh water source. When the dockside water source is attached to the intake valve of a vessel having a breach in its' fresh water system, water escapes from the breach into the interior of the vessel.

A breach can result from a damaged fresh water system or from a water valve of the marine vessel being left in an open or partially open position. Because a dockside water source is pressurized, water can rapidly accumulate within the interior of a vessel due to the breach. The accumulation of water can result in water damage, the capsizing of the vessel, or even in a vessel sinking. Sinking at port due to fresh water system breaches is a common occurrence.

Problems with fresh water system breaches can be minimized through precautionary practices and various conventionally available flow management systems. Each of these conventionally utilized problem mitigating techniques has its shortcomings.

One problem mitigating technique involves the use of bilge pumps. Bilge pumps are often used to avert water intake disasters. Bilge pumps can automatically detect water accumulating within the interior of a vessel and can pump the accumulating water out of the vessel. Bilge pumps are ineffective, when the water flowing into the vessel exceeds the capacity of the pumps to pump water out of the vessel. Bilge pumps also do not prevent water damage from occurring. Additionally, bilge pumps can malfunction after extended periods of use, or not operate if the vessel's electrical power has failed.

Another preventive measure is to use pressure regulators between the dockside water source and a vessels' fresh water system. A pressure regulator can reduce the water pressure present at an inlet to a lower level that that present at a corresponding outlet, the outlet being connected to the vessel's fresh water system and the inlet being connect to the dockside water source. By reducing the water pressure fed into the vessel's fresh water system, the risk of creating leaks due to subjecting the vessel's water lines to excessive water pressure is reduced. Additionally, the lowered water pressure within the vessel's fresh water system reduces the rate water can flow through a leak which increases the time required to damage and/or sink the vessel thereby increasing the probability the leak is detected before the vessel excessive damage occurs or the vessel sinks.

Despite these advantages, pressure regulators do not stop the flow of water onto the vessel when a breach exists. Therefore, the vessel having a pressure regulator still remains at risk of damage and/or sinking

Yet another means of preventing disaster due to breaches is to restrict water flow from a dockside source through the use of flow timers, where the flow of water from a dockside source can only occur for a pre-established duration. In this approach, a dockside water source can be directed through a timer controlled shutoff valve before entering the vessel. The shutoff control value only opens for a fixed duration, after which time an automatic shutoff occurs. For example, the shutoff control valve can be set for thirty minutes in the “on position” after which time the flow of water from the dockside source terminates, thereby requiring a human agent to again enable the flow for new 30 minute cycle. The requirement for manual reactivation of the timer is a major inconvenience when water is required after the end of the time out period, such as in the middle of night or during inclement weather. This would entice the occupants to override the device and leave the vessel unprotected.

### SUMMARY OF THE INVENTION

The present invention details a water intake control system and method for marine vessels that automatically monitors a vessel's fresh water system, detects breaches in this system, and responsive to the detection of a breach automatically halts the flow of water from a dockside source. More particularly, the present invention includes a pressure regulating valve coupled between a dockside water source and a vessel water system. The pressure regulating valve can be adjusted from a fully open position, where water freely flows, to a closed position, where water flow is stopped, and to settings in between these extremes. One or more flow monitors and/or pressure sensors can detect changes in water pressure indicative of a breach in a vessel's water system. When such a change of pressure is detected, the flow of water to the vessel can be automatically halted until the source of the pressure change is identified and/or corrected.

The present invention can overcome the shortcomings of conventional approaches to controlling the intake of water into a vessel from a fresh water source. That is, the present invention permits the unsupervised use of a vessel's water system without any inconvenience or risk to the vessel.

The present invention can be implemented in accordance with numerous aspects consistent with material presented herein. For example, one aspect of the present invention can include a system for providing water to a marine vessel. The system can include a water source for providing water to marine vessels, a water system of a marine vessel, and a flow control mechanism. The flow control mechanism can include a flow control valve, at least one sensor, and flow control electronics. The sensor can sense a condition relating to water flowing between the water source and the water system. The flow control electronics can automatically determine based at least in part upon data provided by the sensor whether a breach exists within the water system. The flow control electronics can automatically close the flow control valve upon detecting a breach.

Another aspect of the present invention can include a flow control mechanism for controlling a flow of water from a water source to a water system of a marine vessel. The flow control mechanism can include a water inlet, a water outlet, a flow control valve, at least one sensor, and flow control electronics. The water inlet can couple the mechanism to the water source. The water outlet can couple the mechanism to the water system. The flow control valve can have an open setting and a closed setting. The open setting can allow water to flow between the water inlet and the water outlet. The closed setting can prevent water from flowing between the water inlet and the water outlet. The sensor can sense a condition relating to water flowing between the water source and the water system. The flow control electronics can automatically determine based at least in part upon data provided by the sensor whether a breach exists within the water system. The flow control electronics can automatically adjust the flow control valve from the open setting to the closed setting upon detecting a breach.

Still another aspect of the present invention can include a method for controlling water intake from a water source to a marine vessel. The method can include the step of coupling a flow control mechanism between the water source and a water system of the marine vessel. The flow control mechanism can control a flow control valve having at least an open setting and a closed setting. The open setting can allow water to flow between the water source and the water system. The closed setting can prevent water from flowing from the water source to the water system.

In the method, the flow control valve can be initially configured for the open setting. Water can be conveyed from the water source to the water system through the flow control mechanism. During the conveying step, a condition relating to water flowing between the water source and the water system can be sensed and used to determine whether a breach exists within the water system. When the condition indicates that a breach exists in the water system, the flow control valve can be responsively and automatically adjusted to the closed setting, which results in water no longer being conveyed from the water source to the open water system. The sensing and adjusting steps of the method can occur without human intervention.

It should be noted that various aspects of the invention can be implemented as hardware, software, and firmware which cause a machine or device to interpret machine readable instructions to perform the functions described herein. Further, the water control apparatus detailed herein can be incorporated within the dockside water source, within the vessel water management system, and/or within an intermediate flow management system coupled between the two systems. The systems can also be compartmentalized, where different ones of the compartmentalized components can be distributed within the vehicle water system, other ones distributed within the dockside water source, and still other compartmentalized components can be placed within an intermediate flow management system.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for controlling water intake in accordance with an embodiment of the inventive arrangements disclosed herein.

FIG. 2 is a flow diagram of a system for controlling water intake in accordance with an embodiment of the inventive arrangements disclosed herein.

FIG. 3 is a schematic diagram of a device for controlling water intake in accordance with an embodiment of the inventive arrangements disclosed herein.

FIG. 4 is a schematic diagram of a vessel equipped with a device for controlling water intake in accordance with an embodiment of the inventive arrangements disclosed herein.

FIG. 5 is a flow diagram of a vessel equipped with a device for controlling water intake in accordance with an embodiment of the inventive arrangements disclosed herein.

FIG. 6 is a flow chart of a method for controlling water intake in accordance with an embodiment of the inventive arrangements disclosed herein.

### DETAILED DESCRIPTION OF THE INVENTION

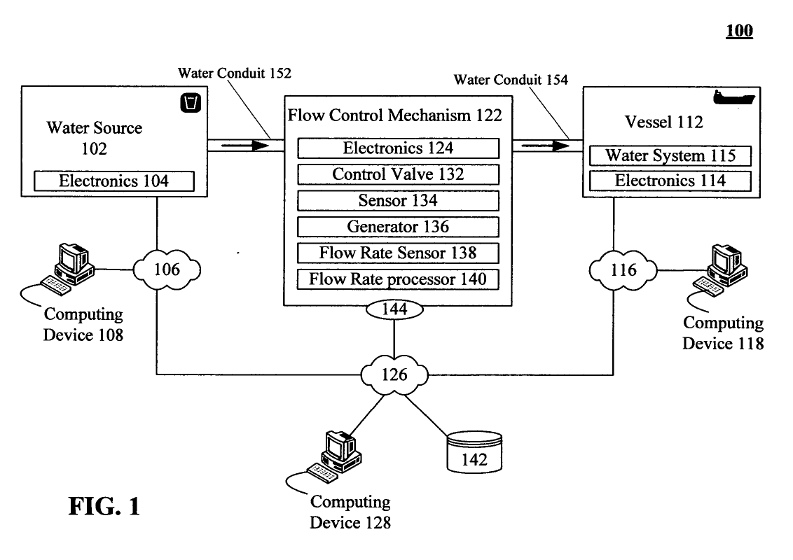

FIG. 1 is a schematic diagram of a system 100 for controlling water intake in accordance with an embodiment of the inventive arrangements disclosed herein. System 100 can include a water source 102 connected to a flow control mechanism 122 through water conduit 152, which is in turn connected to vessel 112 through water conduit 154.

Water source 102 can be represent any water providing source for vessels. Water source 102 can, for example, be a dockside water source for supplying fresh water to vessel 112 while the vessel 112 is docked. System 100 is not to be construed as limited in this regard, however, and water source 102 can represent any water source.

Vessel 112 is a marine vessel having a water system 115. Vessel 112 can include, but is not limited to a yacht, a cruise liner, a fishing boat, a houseboat, a speed boat, an aircraft carrier, a submarine, and the like.

The flow control mechanism 122 can be used to control water intake to the water system 115. The flow control mechanism 122 can include flow control electronics 124, a flow control valve 132, and one or more sensors 134. Each sensor 134 can sense a condition relating to water flowing between the water source 102 and the vessel 112. The sensed condition can be a water pressure, a water level, a water flow rate, and the like.

The flow control electronics 124 can use data obtained by sensors 134 to determine whether a breach exists with the water system 115. When a breach is detected or if the flow control electronics 124 determine that the likelihood of a breach existing exceeds a previously established threshold, the flow control electronics 124 can automatically close the flow control valve 132, thereby preventing the flow of water through the flow control mechanism 122.

In one configuration, the flow control mechanism 122 can also include a generator 136, a flow rate sensor 138, a flow rate processor 140, and/or an interface port 144. The generator 136 can generate power based upon the flow of water through the flow control mechanism 122 from the water source 102 to the vessel 112. The generated power can be used to power the flow control electronics 124, the control valve 132, the sensor 134, the flow rate sensor 138, and/or the flow rate processor 140. For example, the flow control mechanism 122 can include a rechargeable battery (not shown) that supplies power to the flow control electronics 124, control valve 132, sensor 134, flow rate sensor 138, and/or flow rate processor 140 where the battery is recharged by the generator 136. This allows flow control mechanism 122 to operate even if the vessel's electrical power fails. Additionally, the device can monitor the charge of the internal battery and when the battery level falls to a predetermined low level, but still sufficiently high to operate the control valve 132, the device can automatically close the control valve 132. This closure of the control valve insures dockside water cannot damage or sink the vessel when the device is without electrical power. Accordingly, until sufficient battery power is available, the control valve 132 remains in the closed position.

The flow rate sensor 138 can sense the rate of water flow through the flow control mechanism 122. The flow rate processor 140 can use the rate of flow data and the variation of this flow rate with time to compute the Flow Rate Profile of water entering the vessel to determine the possibility of a breach. It should be appreciated that flow rate through flow control mechanism 122 results from the water source 102 having a greater water pressure than the water system 115. If the computed Flow Rate Profile is outside the range of acceptable or safe flow rate profiles, or if the flow rate profile is within the range of known unsafe flow rate profiles, then it is likely that a breach, such as an open water outlet in vessel 112 or a leak in water system 115, exists.

It should be noted that the above example is for illustrative purposes only and that different vessels will have different conditions that indicate a breach. That is, breaches in a vessel's water system can be determined when flow rate profiles are outside normal thresholds established in a profile for the vessel. For example, some vessels will have normal flow rate profiles that are unsafe for other vessels.

To illustrate, in one embodiment, the flow rate processor 140 can access previously stored data from an accessible data storage space, such as profile data store 142. The profile data store 142 can include a plurality of established water flow profiles. Different water profiles can be associated with different vessel 112 types and different water systems 115. Additionally, the water profiles can be suitably configured for the specifications of the water source 102 utilized, which can vary from dock to dock. The flow rate processor 140 can dynamically construct an actual flow profile and compare this against the established water flow profiles of the data store 142. This comparison can permit the flow rate processor 140 to predict whether the water system 115 is breached.

In one embodiment, water profiles stored within the data store 142 can be classified as Acceptable Water Flow Profiles (indicating no breach) and Unacceptable Water Flow Profiles (indicating a breach). That is, Acceptable Water Flow Profiles are stored water flow profiles indicating behavior relating to safe water flows which will not harm or sink the vessel. Examples of acceptable water flow profiles are a shower, which uses a fairly high flow rate for a period of a few minutes and then ceases; washing hands where the flow rate is moderate for a few minutes and then ceases; and brushing teeth which uses a low to moderate rate for a few minutes and then ceases. There are many other acceptable flow rates that can exist in a vessel and can be stored in the profile data store 142.

Unacceptable Water Flow Profiles are those indicating conditions that could harm or sink the vessel. Examples of unacceptable water flow profiles are a slow leak which is characterized by an initial low flow rate that slowly increases with time; or large leak which has a very high flow rate and continues without change.

It should be noted that in one embodiment, each of the water source 102, the flow control mechanism 122, and the vessel 112 can be self-contained systems operating independent of other system 100 components.

In a different embodiment, the various components of system 100 can be communicatively linked to external computing devices, information sources, administrative terminals, user displays, and to one another. Communicatively linking these components can increase the accuracy and responsiveness of the system 100 and can enable remote administration and/or monitoring of the water filling process.

In an embodiment having a communication backbone, electronics 104 of water source 102 can be communicatively linked to electronics 114 of vessel 112, as well as to electronics 124 of flow control mechanism 122. The communication link can occur across network 106, network 116, and/or network 126. Each network 106, 116, and 126 can also connect one or more system 100 components to a computing device, such as computing device 108, 118, and/or 128, and can also provide access to memory spaces containing information, such as profile data store 142. One or more interface ports, such as interface port 144, can facilitate communications between components of system 100.

The functions of the communication backbone within system 100 become clear using an illustrative example. In the example, interface port 144 can permit an administrator to adjust the profiles within the profile data store 142 using a computing device linked to the flow control mechanism 122 via interface port 144. For instance, a vessel's captain can utilize computing device 128 linked to port 144 and data store 142 to refine or customize the data for the specific vessel in which the flow control mechanism 122 is utilized, such as vessel 112. During this adjustment, the captain can enter a specific water pressure desired for the vessel's fresh water system.

In one embodiment, the electronics 122, profile data store 142, and electronics 114 can work in combination to allow an owner of vessel 112 to “teach” the flow control mechanism 122 new water flow profiles. In such an embodiment, the flow control mechanism 122 can be placed into a “learn new Water Flow Profile mode.” While this mode is enabled, specific standard ship tasks can be conducted, such as using a hose to clean the boat. After this water usage is over, a new profile specifying the conditions existing for cleaning the boat can be stored the water usage as an Acceptable Water Flow Profile. The user could also create and store Unacceptable Water Flow Profiles after placing the flow control mechanism 122 in the “learn new Water Flow Profile mode”.

It should be appreciated that the arrangements shown in FIG. 1 are for illustrative purposes only and that the invention is not strictly limited in this regard. For example, in one contemplated embodiment, the flow control mechanism 122 can be integrated within the vessel 112 and/or the water source 102. In another contemplated embodiment, the various components illustrated for flow control mechanism 122 can be distributed within a plurality of different devices, including devices local to water source 102 or vessel 112, devices inserted within the water conduits 152, or 154, and other devices (not shown) connected to the water flow path existing between water source 102 and/or water system 115.

It should also be appreciated that the various components of system 100 can be manufactured in any of a variety of different manners and using different materials in accordance with industry standard practices. For example, in one embodiment, selective components of the flow control mechanism 122 can be formed of a high impact, heat resistant polymer, which does not contain metals to avoid deterioration (rust and corrosion) from the marine environment. Similarly, the electronics 122 can be constructed, isolated, and/or protected to ensure their operation within the marine environment.

As used herein, networks 106, 116, and 126 can represent any communication medium capable of conveying digitally encoded information. In one embodiment, network 106, 116, and/or 126 can comprise a communication bus, a serial or parallel communication line, a BLUETOOTH, IR, or WIFI wireless pathway, or an etched communication path within a circuit board or processor. Additionally, each network 106, 116, and/or 126 can represent a complex communication network through which information can be exchanged. For example, each of the networks 106, 116, and 126 can include a telephony network like a public switched telephone network (PSTN) or a mobile telephone network, a computer network like a local area network or a wide area network, a cable network, a satellite network, a broadcast network, and the like. Networks 106, 116, and 126 can use wireless as well as line based communication pathways.

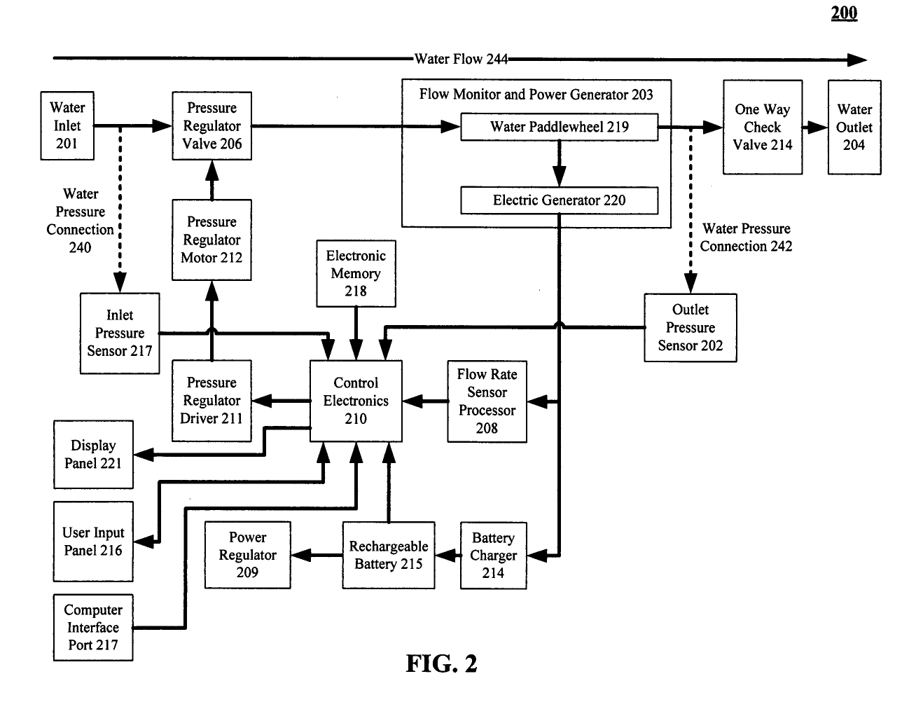

FIG. 2 is a flow diagram of a system 200 for controlling water intake in accordance with an embodiment of the inventive arrangements disclosed herein. The system 200 can represent one contemplated embodiment of the arrangements detailed in system 100. In system 200, it is assumed that water inlet 201 is connected to a water source, that water outlet 204 is connected to a water system of a vessel, and that the direction of water flow 244 is from the water inlet 201 to the water outlet 204.

In system 200, water can flow from water inlet 201 through pressure regulator valve 206 to flow monitor and power generator 203. The water from water inlet 201 can also be connected via a water pressure connection 240 to inlet pressure sensor 217. Within the flow monitor and power generator 203, water can turn water paddlewheel 219, which actuates electric generator 220. The water paddlewheel 219 can also be used to determine the rate of flow for the water. Water can pass from the flow monitor and power generator 203 through a one way check valve 214 to water outlet 204. The water from the flow monitor and power generator 203 can also be conveyed via water pressure connection 242 to outlet pressure sensor 202.

While the water is flowing, various electronic signals are being generated by system 200 components responsive to the water flow. Inlet pressure sensor 217, outlet pressure sensor 202, and flow rate sensor processor 208 can convey data to control electronics 210. Flow rate sensor processor 208 can process data generated by the flow monitor and power generator 203. The control electronics 210 can also have access to electronic memory 218. Control electronics 210 can adjust pressure regulator valve 206 settings. For example, the control electronics 210 can interface with one or more pressure regulator drivers 211 that format data into a form understood by the pressure regulator motor 212. The pressure regulator motor 212 can responsively adjust the pressure regulator valve 206 between an open position, a closed position, as well as intermediate positions.

Control electronics 210 can receive signals from and convey signals to external systems. For example, the control electronics 210 can receive digitally encoded signals via computer interface port 217. The computer electronics 210 can also receive input from user input panel 216 and provide information to display panel 221.

The electronic generator 220 can generate power for the battery charger 214, which recharges rechargeable battery 215. Power from rechargeable battery 215 can be provided to the control electronics 210. The rechargeable battery 215 can also be used to power other components of system 200, such as inlet pressure sensor 217, outlet pressure sensor 202, pressure regulator motor 212, flow rate sensor processor 208, pressure regulator driver 211, and the like. The rechargeable battery 215 can function as a backup power supply that permits system 200 to function when other power fails. In particular embodiments, the power supplied by rechargeable battery 215 can be regulated by power regulator 209.

Additionally, system 200 can monitor the rechargeable battery 215 to ensure that the battery 215 maintains a minimal charge necessary to operate the system 200. When the charge of the battery 215 falls below a previously established minimum threshold, the system 200 can be automatically adjusted to a safe state. For example, the pressure regulator motor 212 can adjust the pressure regulator valve 206 to prevent the intake of water to ensure that the system 200 is not left in an open state when there is not power to the system. Other safety measure can be taken to ensure that in the event of an unexpected system component failure, the pressure regulator valve 206 is automated adjusted to a closed position.

It should be understood that the components of system 200 can be configured in various ways and can be constructed using any of a plurality of discrete and commonly available components.

For example, water inlet 201 can be a standard female water connector as is widely used in the marine industry so that a conventional water hose such as those used at marinas can be used to connect the present invention to the dockside water supply.

The pressure regulating valve 206 can be a common device configured for controlling fluid flow that changes water flow rate. Examples of pressure regulating values can include, but are not limited to, facets found in households that control the water flow in sinks, bathtubs, and showers, thermostats used in the cooling systems of gasoline and diesel engines, and the pressure regulators of many household lawn sprinkler systems.

Pressure regulating valve 206 can also be implemented as using plunger-type elements found in many controlled water flow systems such as the thermostat element in the cooling system of automobiles. Such a pressure element would be controlled by an electric motor and gear combination or an electric solenoid.

In one embodiment, the water monitor and power generator 203 can be implemented with a water paddlewheel 219 and an electric generator 220. This invention is not to be limited in this regard, however, and any flow monitor or sensor can be utilized. The electric generator 220 is an optional component included in arrangements that generate power from the water flow 244.

The water paddlewheel 219 can rotate by the force of the water passing over it. The water paddlewheel 219 can be connected to electric generator 220 by either mechanical or magnetic means. This connection causes the electric generator 220 to rotate in conjunction with the water paddlewheel 219. When rotated, the electric generator 220 produces electrical power whose characteristics vary with its rotational speed. This manner of electric power generation is common and familiar to those skilled in the art of electric power generation.

The inlet pressure sensor 217 can produce an electronic signal whose characteristics are dependent on the water pressure at the water inlet 201. The outlet pressure sensor 202 can produces an electronic signal whose characteristics are dependent on the water pressure at the water outlet 204. The control electronics 210 may compare the pressure differences between these two pressure sensors to calculate the water flow rate into the vessel. This flow rate prediction may be used in conjunction with, or instead of, the flow rate sensed by the combination of the flow monitor and power generator 203 and the flow rate sensor processor 208 to enhance the accuracy of the measured flow rates, and/or to provide a backup flow sensor to overcome failure.

The user input panel 216 can be a dedicated input device connected to the control electronics 210 or can be a detachable input device, such a peripheral device of a computer that interfaces with the control electronics 210. The dedicated device can include such input mechanisms as buttons, switches, a keypad, or a microphone coupled to a voice recognition system.

The control electronics 210 can be capable of performing mathematical computation and digital processing functions. The control electronics 210 can be implemented with any form of digital electronic circuitry. Examples of such logic are discrete digital logic, a field programmable logic array, a microprocessor, and the like.

One way water check valve 214 can prevent water flow out of the vessel. Although the normal pathway while at port of the water flow is from the dockside source into the vessel, the normal pathway of water when not at port is different. When not connected to a dockside water source, the vessel uses its onboard fresh water storage tank to supply the occupants with fresh water. When this water source is used, the water pressure at the outlet water connector 204 can be relatively high pressured, which would force water to travel in a backwards fashion, or to travel towards the water inlet 201. The one way water check valve 214 is used to prevent this undesired backwards water flow.

It should be appreciated that the inventive arrangements of system 200 are provided for illustrative purposes only and that modifications to these arrangements resulting in approximately equivalent functionality are contemplated herein. For example, although the inlet pressure sensor 217 and outlet pressure sensor 202 are shown to be located in the interior of system 200, either or both of the sensors can be located on the exterior of system 200, such as located within the inlet pipeline, within the water source, within the outlet pipeline, or within the water system of the vessel. In one embodiment, system 200 can operate with a single pressure sensor, which can be either an inlet pressure sensor or an outlet pressure sensor.

In another embodiment, the flow monitor and power generator 203 need not be implemented as a water paddlewheel 219 that powers an electronic generator 220, but can instead be implemented by any flow monitoring device combined with any backup power system. The backup power system can be directly recharged by a constant power source such as the power source that normally provides power for the system 200.

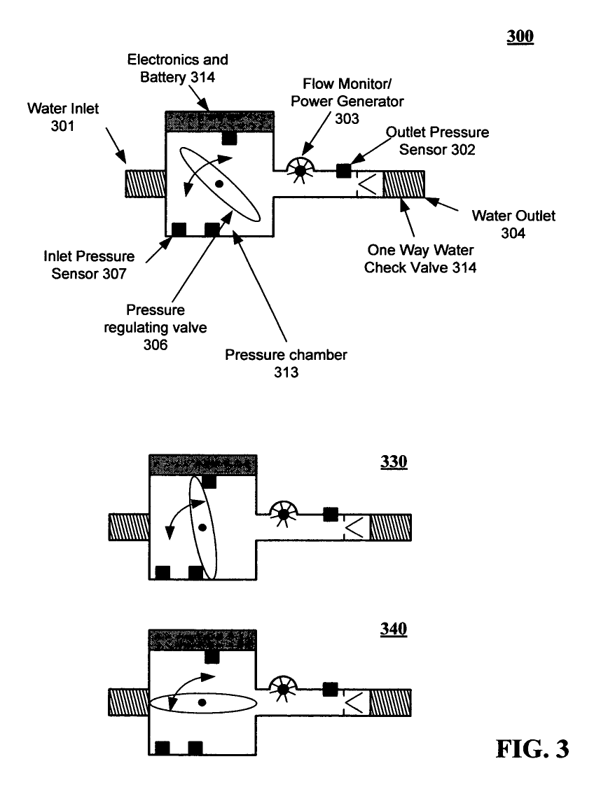

FIG. 3 is a schematic diagram of devices for controlling water intake in accordance with an embodiment of the inventive arrangements disclosed herein. FIG. 3 illustrates three different devices, each having a pressure regulating valve 306 adjusted for a different position. Device 300 illustrates a semi-open or intermediate position, device 330 illustrates a closed position, and device 340 illustrates a fully opened position. Devices 300, 330, and 340 can represent one configuration for the flow control mechanism 122 of FIG. 1. Other than the position of the pressure regulating valve 306, each of the devices 300, 330, and 340 are identical. Thus, the single device can be placed in positions shown by device 300, 330, and 340, as the single device is adjusted for different operating states.

Water can flow into device 300 via water inlet 310 from a water source. The water then flows into pressure chamber 313. The pressure regulating valve 306 can segment the pressure chamber into two different sections, each having a different water pressure. An inlet pressure sensor 307 can be placed within the segment associated with water inlet 301. An outlet pressure sensor 302 can be placed within the segment associated with water outlet 304. Device 300 can include electronics and battery 314 components for adjusting the pressure regulating valve 306. It should be appreciated that the battery is not needed in embodiments that use an alternative power source, such as an external power line or power generated directly from power generator 303. Water can flow from the pressure chamber 313 past flow monitor/power generator 303 towards the water outlet 304. A one way water check valve 314 can be included within the device to prevent backflow.

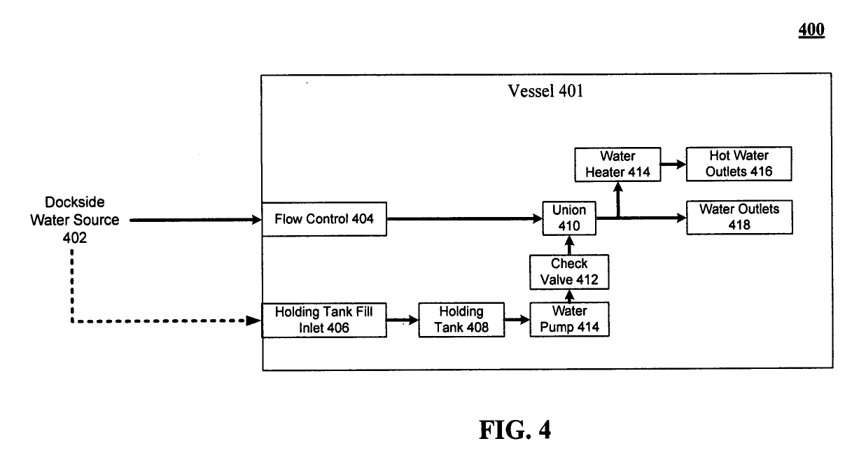

FIG. 4 is a schematic diagram 400 of a vessel 401 equipped with a device for controlling water intake in accordance with an embodiment of the inventive arrangements disclosed herein. Diagram 400 illustrates that the device for controlling water intake can be integrated within vessel 401. That is (referring to FIG. 1), the flow control mechanism 122 of system 100 can be integrated within the vessel 112 and need not be an intermediate component between the water source 102 and the vessel 112. It should be appreciated that the control mechanism 122 can be similarly integrated with the water source 102, which is not shown by a separate figure, but such an adaptation is contemplated herein and is within the ability of one of ordinary skill in the art.

In diagram 400, a dockside water source 402 is connected to flow control 404, which is the device that controls the intake of water. Water can also be provided to the vessel 401 through an alternative connection. For example, the holding fill tank inlet 406 can be linked to the dockside water source 402. Water can flow from the holding fill tank inlet 406, to the holding tank 408. Once there, water pump 414 can force water from the holding tank 408 through check valve 412. Water from flow control 404 and check valve 412 can merge at union 410. From union 410, water can be conveyed to points of water use within the vessel such as water heater 414, water outlets 418, and the like.

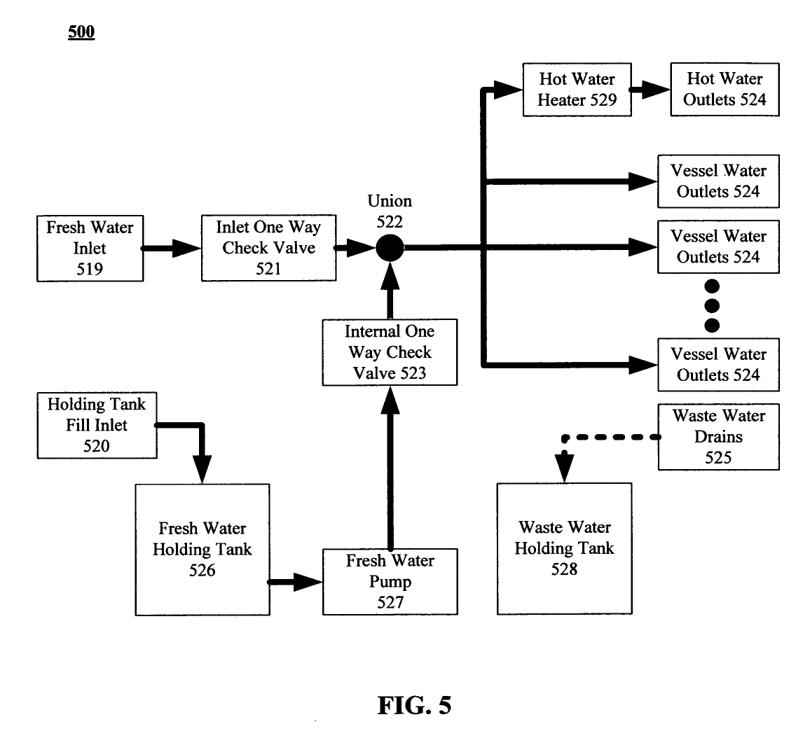

FIG. 5 is a diagram 500 that illustrates a flow of water for the system of FIG. 4. Fresh water can be distributed throughout a vessel from a dockside pressure source linked to the fresh water inlet 519 and/or from the vessel's internal fresh water holding tank 526. Regardless of which source is used to provide fresh water, fresh water can flow from union 522 to the various water outlets of the vessel.

In diagram 500, fresh water inlet 519 can be linked to inline one way check valve 521, which is in turn linked to union 522. Additionally, a holding tank fill inlet 520 can be connected to fresh water holding tank 526. Fresh water pump 527 can convey the water within the fresh water holding tank 526 through internal one way check valve 523 to union 522.

From union 522, water can be conveyed to vessel water outlets 524, a portion of which can be first routed though hot water heater 529. Water from the vessel water outlets 524 can pass to waste water drains 525, which convey water to waste water holding tank 528.

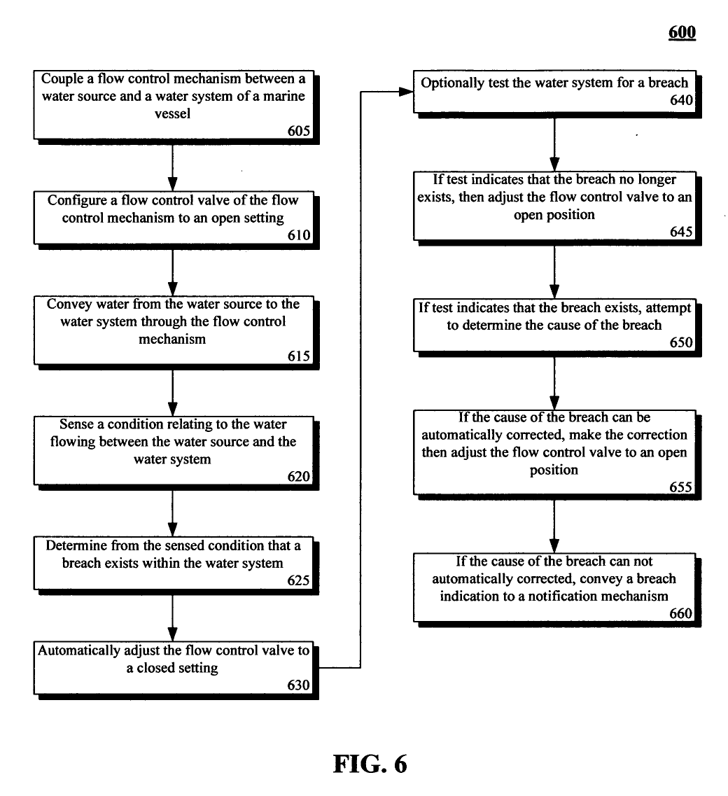

FIG. 6 is a flow chart of a method 600 for controlling water intake in accordance with an embodiment of the inventive arrangements disclosed herein. The method 600 can be performed in any context where a device automatically controls the flow of water between a water source and a marine vessel. For example, the method 600 can be performed in the context of system 100.

Method 600 can begin in step 605, where a flow control mechanism can be coupled between a water source and a water system of a marine vessel. In step 610, a flow control valve of the flow control mechanism can be set to an open setting. In step 615, water can be conveyed from the water source to the water system through the flow control mechanism. In step 620, a condition relating to the water flowing between the water source and the water system can be sensed.

In step 625, a determination can be made based upon the sensed condition that a breach exists within the water system. If a breach is not determined to exist, water can continue to flow through the flow control mechanism and breach condition checking can continue. In step 630, after the breach was detected, the flow control valve can be automatically adjusted to a closed setting. This automatic closing action can prevent water from continuing to flow from a breached water system into the interior of a marine vessel, which would otherwise result in water damage, capsizing, and/or sinking.

In optional step 640, the water system can be tested for a breach. Any of a variety of tests can be performed at this step. For example, the flow control valve can be opened slightly to determine if an outlet pressure sensor detects a pressure increase. If an increase is detected, the flow control valve can be gradually re-opened, each opening increment being accompanied by another check of the outlet pressure sensor's reading. It should be noted that the water system of a marine vessel become increasing pressurized as water is added to the system, assuming that the system is not leaking. Accordingly, the tested increase in pressure can be compared against an expected threshold associated with the water flow rate and the water level currently within the vessel's water system. When a favorable comparison occurs, the test can indicate that no breach exists. When a non-favorable comparison occurs, the test can confirm that a breach exists.

It should be noted that testing can occur after a previously established delay passes in certain embodiments. This delay period can be observed so that a temporarily condition indicative of a breach, which is not actually a breach, may pass.

For instance, a vessel owner could be using large quantities of water in a manner that would otherwise be detected as a breach, such as in cleaning the vessel. When the control system senses this breach, it closes the flow control valve shutting off the water flow which would stop the water flow to the owner cleaning the vessel. The owner could then shut off his hose, which would be detected by the control mechanism as previously described. The control mechanism would reopen the control valve allowing water to flow to the owner. This process would repeat until the abnormal, but safe water usage was completed. This feature allows the water intake control system to compensate for various operational conditions, which can be user configured, without a need for manual system overrides.

In step 645, if the test indicates that the breach no longer exists, then the flow control valve can be re-adjusted to an open position, where water can flow into the water system.

In step 650, if the test indicates that a breach exists, then an attempt can be made by an automated system to determine the cause of the breach. In step 655, if the cause of the breach can be automatically corrected, then the necessary correction can be made. For example, the flow control system can be communicatively linked to the water outlets on the vessel, which can be electronically controlled. Step 655 can indicate that one of these water outlets is open, which the flow control system can automatically close. Similarly, a series of electronically controlled shut off valves can be included within water conduits of the vessel, which the flow control system can shut off to seal a leaking portion of the water system from the water source. After an automatic correction is performed, the flow control valve can be automatically adjusted to an open position, which causes water to flow from the water source to the water system of the vessel.

In step 660, if the cause of the breach cannot be automatically corrected, a breach indication can be conveyed to a notification mechanism. Any of a variety of breach indications and notification mechanisms are contemplated herein. For example, the breach indication can cause a warning light to flash or an alarm to sound. The warning light/alarm can be located at the water source, at the flow control mechanism, and/or within the vessel. In another example, the notification mechanism can cause an email message or voice mail message to be conveyed to a previously established email address or telephone number. Regardless of the notification mechanism, the flow control valve can remain in a closed position until the detected breach is corrected.

The present invention may be realized in hardware, software, firmware, or combinations thereof. The present invention may be realized in a centralized fashion or in a distributed fashion where different elements are spread across several interconnected sub-systems. Any kind of system or other apparatus adapted for carrying out the methods and functions described herein is suited.

This invention may be embodied in other forms without departing from the spirit or essential attributes thereof. Accordingly, reference should be made to the following claims, rather than to the foregoing specification, as indicating the scope of the invention.

What is claimed is:

1. A system for providing water to a marine vessel comprising:
a water source for providing water to marine vessels;
a water system of a marine vessel; and
a flow control mechanism comprising a flow control valve, at least one sensor, and flow control electronics, wherein the sensor is configured to sense a condition relating to water flowing between the water source and the water system, wherein flow control electronics are configured to automatically determine based at least in part upon data provided by the sensor whether a breach exists within the water system, and wherein the flow control electronics are configured to automatically close said flow control valve upon detecting a breach, wherein water is prevented from flowing from the water source to the water system when the flow control valve is closed.

2. The system of claim 1, said flow control mechanism further comprising:
an electric generator configured to generate power based upon a flowing of water from the water source to the water system, wherein the generated power is used to charge an internal battery.

3. The system of claim 1, wherein said system further comprises:
a flow rate sensor configured to sense a rate of water flow verses time between the water source and the water system; and
a flow rate processor configured to determine a possibility of a breach based upon water flow data provided by the rate flow sensor, wherein the flow control electronics use said flow rate processor to detect breaches in the water system. (Is this the place to add time to the water profile parameter?)

4. The system of claim 3, further comprising:
a profile data store comprising a plurality of established water flow profiles, wherein particular ones of the profiles are indicative of a breach and wherein other ones of the profiles are indicative that no breach exists, wherein said rate flow processor compares data provided by the rate flow sensor against at least one profile stored within the profile data store to determine the possibility of a breach.

5. The system of claim 1, wherein said at least one sensor comprises a water pressure sensor, and wherein the automatic determination of said breach is based at least in part upon a pressure determined by the water pressure sensor.

6. The system of claim 5, wherein the at least one water pressure sensor is associated with at least one user configurable value.

7. The system of claim 6, wherein the at least user configurable value includes a lower boundary that represents a minimum pressure for the water system.

8. The system of claim 6, wherein the boundary is an upper boundary that represents a maximum pressure for the water system.

9. The system of claim 1, wherein said at least one sensor includes a sensor to measure at least one of a rate of water flow and an amount of water that passes into the water system from the water source.

10. The system of claim 9, further comprising:
a user configurable value, which is compared against a value from the sensor, where said control valve is automatically closed based upon a comparison of the user configurable value and the value from the sensor.

11. The system of claim 1, wherein the water source further comprises a source electronic device, wherein said source electronic device is communicatively linked to said flow control electronics, wherein data is provided from the source electronic device to the flow control electronics, said data from the source electronic device being used to automatically determine whether said breach exists.

12. The system of claim 1, wherein the marine vessel further comprises a vessel electronic device, wherein said vessel electronic device is communicatively linked to said flow control electronics, wherein data is provided from the vessel electronic device to the flow control electronics, said data from the vessel electronic device being used to automatically determine whether said breach exists.

13. A flow control mechanism for controlling a flow of water from a water source to a water system of a marine vessel, said mechanism comprising:
a water inlet for coupling said mechanism to said water source;
a water outlet for coupling said mechanism to said water system;
a flow control valve having at least an open setting and a closed setting, wherein the open setting allows water to flow between the water inlet and the water outlet, and wherein the closed setting does not allow water to flow between the inlet and the water outlet;
at least one sensor configured to sense a condition relating to water flowing between the water source and the water system; and
flow control electronics configured to automatically determine based at least in part upon data provided by the sensor whether a breach exists within the water system, and wherein the flow control electronics are configured to automatically adjust said flow control valve from the open setting to the closed setting upon detecting a breach.

14. The mechanism of claim 13, further comprising: an electric generator configured to generate power based upon a flowing of water from the water source to the water system.

15. The mechanism of claim 14, further comprising:
a rechargeable battery for supplying power to said flow control electronics, wherein said electronic generator charges said battery.

16. The mechanism of claim 13, further comprising:
a paddlewheel configured to turn responsive to water pressure of water flowing between the water inlet and the water outlet.

17. The mechanism of claim 16, wherein said paddlewheel is one of said at least one sensor used to sense a rate of flow of water through the mechanism.

18. The mechanism of claim 16, wherein said paddlewheel is used to generate power for the flow control electronics.

19. The mechanism of claim 13, wherein said flow control valve is disposed within a pressure chamber and wherein said flow control valve separates said pressure chamber into an inlet pressure section and an outlet pressure section.

20. The mechanism of claim 19, wherein said at least one sensor comprises:
an inlet pressure sensor configured to sense pressure in said inlet pressure section ;and
an outlet pressure sensor configured to sense pressure in said outlet pressure section.

21. The mechanism of claim 13, further comprising:
a flow rate sensor configured to sense a rate of water flow between the water source and the water system; and
a flow rate processor configured to determine a possibility of a breach based upon water flow data provided by the rate flow sensor, wherein the flow control electronics use said flow rate processor to detect breaches in the water system.

22. The mechanism of claim 21, further comprising:
a profile data store comprising a plurality of established water flow profiles, wherein particular ones of the profiles are indicative of a breach and wherein other ones of the profiles are indicative that no breach exists, wherein said rate flow processor compares data provided by the rate flow sensor against at least one profile stored within the profile data store to determine the possibility of a breach.

23. The mechanism of claim 13, further comprising:
a computer interface port communicatively linked to said flow control electronics, wherein a remotely located computing device is able to utilize said computer interface port to retrieve data associated with said mechanism.

24. The mechanism of claim 23, wherein said computer interface port is configured to permit said remotely located computing device to convey commands to said mechanism, wherein the flow control electronics are configured to perform programmatic actions responsive to the commands, said programmatic actions adjusting the rate of water flow between the water inlet valve and the water outlet.

25. The mechanism of clam 23, wherein the computer interface port is a network port configured to convey packets containing digitally encoded information across a computer network.

26. A method for controlling water intake for a marine comprising:
coupling a flow control mechanism between a water source and a water system of a marine vessel, said flow control mechanism controlling a flow control valve having at least an open setting and a closed setting, wherein the open setting allows water to flow between the water source and the water system, and wherein the closed setting does not allow water to flow from the water source to the water system;
configuring the flow control valve to the open setting;
conveying water from the water source to the water system through the flow control mechanism;
during the conveying step, automatically sensing a condition relating to water flowing between the water source and the water system to determine whether a breach exists within said water system; and
when the sensed condition indicates that a breach exists in the water system, responsively and automatically adjusting the flow control valve to the closed setting, which results in water no longer being conveyed from the water source to the open water system, wherein the sensing and adjusting steps occur without human intervention.

27. The method of claim 26, further comprising:
restricting a flow of water to a unidirectional flow, said unidirectional flow being from the water source to the water system.

28. The method of claim 26, wherein the water system is a fresh water system of the marine vessel, wherein the water source is a dockside pressurized water source, wherein the flow control mechanism comprises an inlet connector coupled to the water source and an outlet connector coupled to the water system, and wherein said flow control valve is located between said inlet connector and said outlet connector.

29. The method of claim 26, wherein said flow control mechanism comprises control electronics and an electric generator, wherein said adjusting step further comprises adjusting said flow control value using said control electronics, wherein said electric generator generates power based upon a flowing of water from the water source to the water system, and wherein power for said control electronics is provided at least in part by a battery charged using the power generated by said electric generator.

30. The method of claim 29, further comprising:
detecting that a charge in the battery falls below a previously determined threshold; and
responsive to the detecting step, automatically adjusting the flow control valve to the closed setting.

31. The method of claim 26, wherein said flow control mechanism comprises flow control electronics, at least one sensor, and a profile data store, said method further comprising:
dynamically computing a water flow profile using data provided by the at least one sensor, said water flow profile being associated with water flow corresponding to a flow of water from the conveying step; comparing the dynamically computed water flow profile against at least one pre-existing profiles of the profile data store; and
the flow control electronics performing the adjusting step responsive to results of the comparing step.

32. The method of claim 26, further comprising:
presenting an indicator of a setting of the flow control valve, a breach indicator for the water system, and a water flow indicator within a user interface.

33. The method of claim 32, wherein said user interface is a graphical user interface of a computing device communicatively linked to flow control electronics of the flow control mechanism.

34. The method of claim 33, wherein the computing device is remotely located from the flow control mechanism.

35. The method of claim 33, wherein said computing device is located within said marine vessel and is communicatively linked to at least one vessel electronic device.

36. The method of claim 33, wherein said computing device is communicatively linked to at least one source electronic device for the water source, wherein said computing device simultaneously presents indicators associated with a plurality of different marine vessels.

37. The method of claim 33, wherein the computing device is a Web enabled device having a Web browser, wherein the computing device is communicatively linked to the flow control electronics through a computer network, wherein said presenting step further comprises presenting the indicator within the Web browser.
